(19) United States
(12) Patent Application Publication
(10) Pub. No.: US 2009/0147245 A1
(43) Pub. Date: Jun. 11, 2009

(54) SYSTEM AND METHOD FOR MEASURING OPTICAL RESOLUTION OF LENS

(75) Inventor: KUN-I YUAN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/170,761

(22) Filed: Jul. 10, 2008

(30) Foreign Application Priority Data
Dec. 11, 2007 (CN) 200710202987.5

(51) Int. Cl. G01M 11/02

(52) U.S. Cl. 356/124

(57) ABSTRACT

A system for measuring optical resolution of a lens, is provided. The system includes a chart, an image sensor, a lens tray, and a processor. The chart has a frame pattern and a number of line pair patterns arranged in the frame pattern. The image sensor is center-aligned with the frame pattern of the chart and configured for capturing an image of the chart. The lens tray is movable relative to the chart for moving the lens to be center-aligned with the frame pattern of the chart and the image sensor based on the frame pattern in the image of the chart. The processor is configured for analyzing the image of the line pair patterns to obtain an optical resolution of the lens.

### BACKGROUND

1. Technical Field

The present invention relates to optical resolution measuring systems, and particularly, to a system and a method for measuring optical resolution of a lens.

2. Description of Related Art

Lenses are key components in cameras, including still cameras and digital cameras. Each of the lenses needs to go through an optical resolution measurement.

Referring to FIGS. 5 and 6, a typical system for measuring optical resolution of a lens 10, is provided. The system includes a light source 11, a chart 12, an image sensor 13, a processor 14 and a display 15. The chart 12 is illuminated by the light source 11. The chart 12 has a number of line pair patterns 122 thereon. The lens 10 receives light reflected by the line pair patterns 122. The image sensor 13 has an image sensing area. The image sensor 13 can receive and convert light transmitted through the lens 10 into electronic image signals associated with the line pair patterns 122. The processor 14 receives and analyzes the image signals associated with the line pair patterns 122 according to a Modulation Transfer Function (MTF), thereby obtaining an optical resolution of the lens 10. The display 15 displays the optical resolution.

During the measurement, a central optical axis of the lens 10 is preferably to be align with that of the image sensor 13, so as to precisely obtain an MTF value to represent the optical resolution of the lens 10. However, it is difficult to locate the central optical axis of the lens 10, especially when a size of the lens 10 is too small.

What is needed, therefore, is a system and method for measuring optical resolution of a lens, which is capable of identifying whether a central optical axis of the lens is aligned with that of the image sensor.

### SUMMARY

An exemplary system for measuring optical resolution of a lens, is provided. The system includes a chart, an image sensor, a lens tray, and a processor. The chart has a frame pattern and a number of line pair patterns arranged in the frame pattern, with each of the line pair patterns including a plurality of black and white line pairs. The image sensor is center-aligned with the frame pattern of the chart and configured for capturing an image of the chart. The lens tray has a through hole for mounting the lens therein. The lens tray is movable relative to the chart for moving the lens to be center-aligned with the frame pattern of the chart and the image sensor based on the frame pattern in the image of the chart. The processor is configured for analyzing the image of the line pair patterns to obtain an optical resolution of the lens.

Other advantages and novel features of the present system will become more apparent from the following detailed description of embodiment when taken in conjunction with the accompanying drawings.

### BRIEF DESCRIPTION OF THE DRAWINGS

Many aspects of the system and method can be better understood with reference to the following drawings. The components in the drawings are not necessarily drawn to scale, the emphasis instead being placed upon clearly illustrating the principles of the present system and method. Moreover, in the drawings, like reference numerals designate corresponding parts throughout the several views.

FIG. 1 is a schematic view of a system for measuring optical resolution of a lens in accordance with an embodiment of the present invention.

FIG. 2 is a plane view of the chart shown in FIG. 1.

FIG. 3 is a schematic view showing the frame pattern in the image of the chart is not centrosymmetric about the center of the image sensing area of the image sensor.

FIG. 4 is another schematic view showing the frame pattern in the image of the chart is not centrosymmetric about the center of the image sensing area of the image sensor.

FIG. 5 is schematic view of a conventional system for measuring optical resolution of a lens.

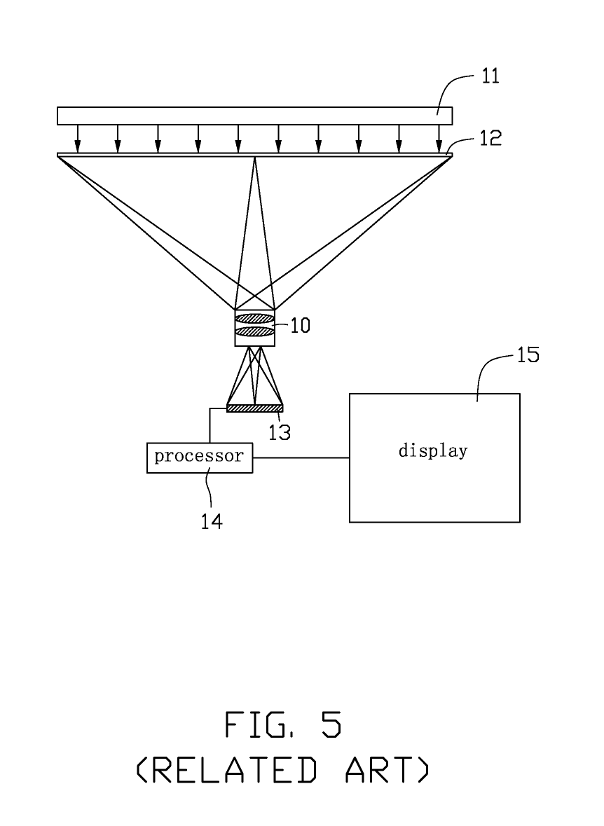

FIG. 6 is a plane view of the chart shown in FIG. 5.

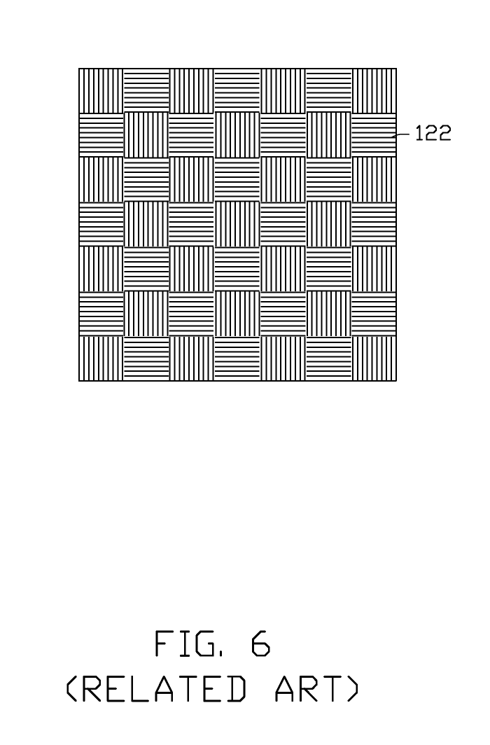

### DETAILED DESCRIPTION OF THE EMBODIMENTS

Embodiments of the present system and method will now be described in detail below and with reference to the drawings.

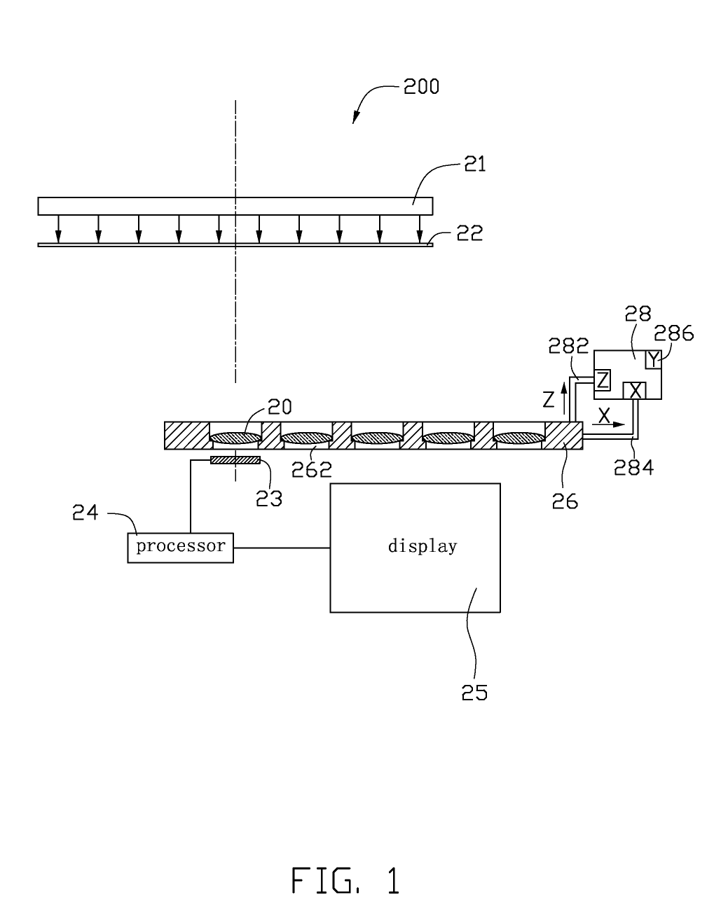

Referring to FIG. 1, an exemplary system 200 for measuring optical resolution of a lens 20, is provided. The measuring system 200 includes a light source 21, a chart 22, an image sensor 23, a lens tray 26, a processor 24 and a display 25.

The light source 21 can be a light emitting diode (LED), and is configured for illuminating the chart 22.

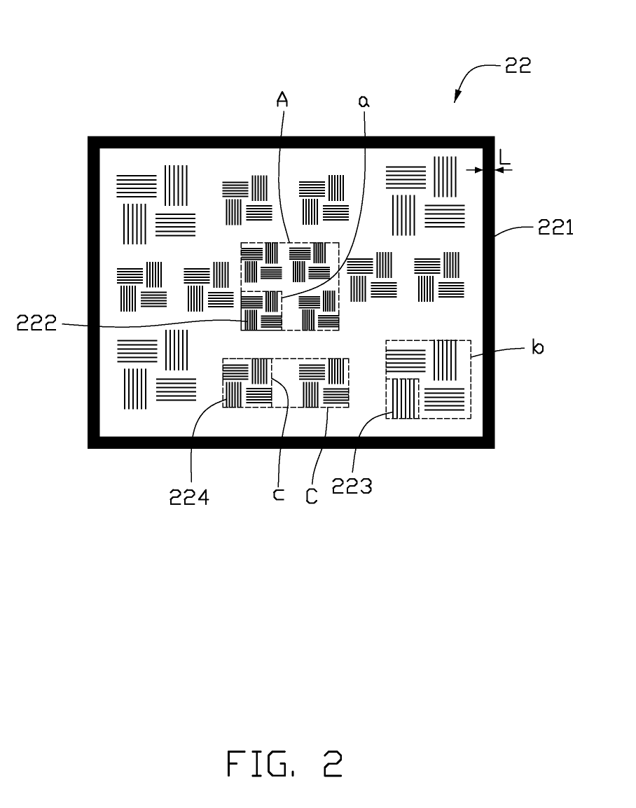

Also referring to FIG. 2, the chart 22 has a frame pattern 221, and a plurality of line pair patterns 222, 223, and 224 arranged in the frame pattern 221. The frame pattern 221 is in a rectangular shape. In order to achieve a clear visibility for the lens 20 and the image sensor 23 to take an image thereof, and to be distinguished from the line pair patterns 222, 223, and 224, the frame pattern 22 is highlighted relative to the line pair patterns 222, 223, and 224, with a width L thereof between 0.5 mm and 2 cm. Each of the line pair patterns 222, 223, and 224 includes a plurality of black and white parallel line pairs. The line pair patterns 222, 223, and 224 are different from each other in spatial frequency, i.e., the number of the black and white line pairs per millimeter distance in each of the line pair patterns 222, 223, 224 is different. In areas a, b and c, the line pairs of adjacent line pair patterns 222, 223, and 224 are perpendicular to each other. An area A in the drawing is comprised of four a areas. An area C in the drawing is comprised of two c areas.

The frame pattern 221 and the line pair patterns 222, 223, 224 faces the lens 20. The lens 20 receives light reflected by the frame pattern 221 and the line pair patterns 222, 223, 224.

The image sensor 23 can be selected from a charge coupled device (CCD) and a complementary metal oxide semiconductor transistor (CMOS). The image sensor 23 has an image sensing area (in present embodiment, the entire top surface area representative of the image sensing area). The image sensor 23 is capable of receiving and converting light transmitted through the lens 20 into electronic image signals associated with the frame pattern 221 and the line pair patterns 222, 223, 224.

The processor 24 is communicatively connected to the image sensor 23. The processor 24 mainly has an analog-to-digital converter and an optical resolution analyzer therein. The analog-to-digital converter is configured for converting the electronic image signals associated with the frame pattern 221 and the line pair patterns 222, 223, 224 from the image sensor 23, which are in a form of analog image signals, into a form of digital image signals. The optical resolution analyzer is capable of analyzing the image signals associated with the line pair patterns 222, 223, 224 from the analog-to-digital converter according to a Modulation Transfer Function (MTF), for example, MTF=(Iₘₐₓ−Iₘᵢₙ)/(Iₘₐₓ+Iₘᵢₙ), with Iₘₐₓ representing an intensity of the white lines in one of the line pair patterns 222, 223, 224 or one of the areas a, b, c, and Iₘᵢₙ representing an intensity of the black lines in the same one of the line pair patterns 222, 223, 224 or one of the areas a, b, c. The optical resolution analyzer can calculate the MTF value for a number of times, thereby capable of providing an average MTF value to represent an optical resolution of the lens 20.

The display 25 is electrically connected to the processor 24.

The tray 26 has a number of receiving holes 262 for mounting lenses 20 therein. The receiving holes 262 are equally spaced from each other. A driving device 28 is provided here. The driving device 28 has a Z axis driving arm 282, an X axis driving arm 284 and a Y axis driving arm 286. The driving device 28 is configured for driving the lens tray 26 to move in the Z, X or Y axis.

A method for measuring optical resolution of a lens 20 using the system 200, is described in the following steps:
(1) arranging the image sensor 23 to align a central axis of the image sensing area of the image sensor 23 with that of the frame pattern 221 of the chart 22;
(2) disposing the lens 20 between the chart 22 and the image sensor 23;
(2) capturing an image of the chart 22 to obtain an image associated with the frame pattern 221 using the image sensor 23;
(3) determining whether the image associated with the frame pattern 221 is centrosymmetric about a center of the image sensing area of the image sensor 23, if not, moving the lens 20 until the image associated with the frame pattern 221 is centrosymmetric about the center of the image sensing area of the image sensor 23;
(4) capturing images associated with the line pair patterns 222, 223, 224 using the image sensor 23; and
(5) analyzing the images associated with the line pair patterns 222, 223, 224 using the processor 24 to obtain an optical resolution of the lens 20.

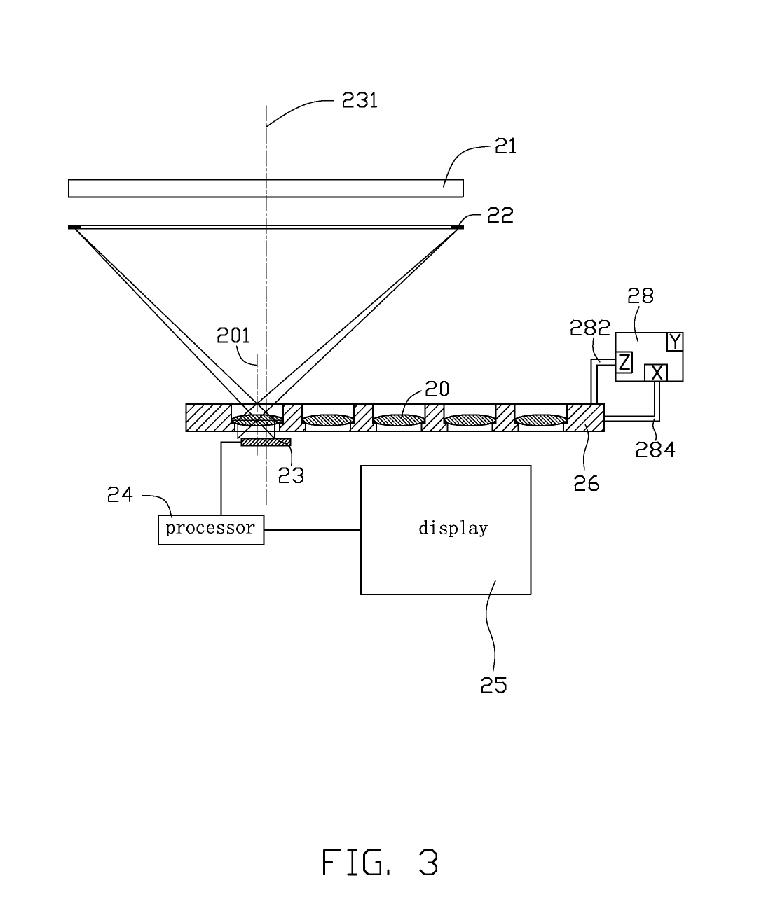

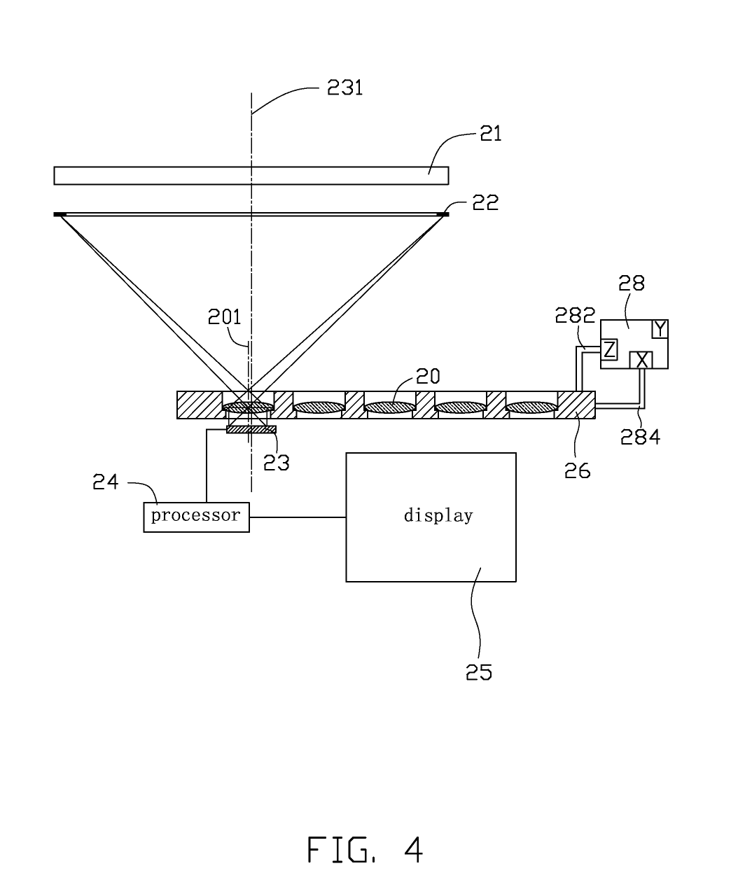

In step (1), referring to FIG. 3, the central axis 231 of the image sensor 23 and that of the frame pattern 221 can be easily defined by geometry. In step (3), also referring to FIG. 3, the image associated with the frame pattern 221 on the image sensor 23 is not intact for the frame pattern 221, but just a partial image for the frame pattern 221, in this case, the image is not centrosymmetric about the center of the image sensing area of the image sensor 23, movement of the tray 26 using the driving device 28 is needed. Referring to FIG. 4, even the image associated with the frame pattern 221 on the image sensor 23 is intact for the frame pattern 221, the image may be still not centrosymmetric about a center of the image sensing area of the image sensor 23, in this case, movement of the tray 26 is still needed. In this way, due to the frame pattern 221 of the chart 22, a central optical axis 201 of the lens 20 can be aligned with that of the image sensor 23 by performing step (3). In steps (4) and (5), the lens 20 and the image sensor 23 can capture an image associated with all of the line pair patterns 222, 223, and 224 therein, or capture images associated with the respective line pair patterns 222, 223, and 224, and the processor 24 can process the respective images and thus obtain an optical resolution of the lens 20.

Image signals associated with the frame pattern 221 from the image sensor 23 can be first processed by the analog-to-digital converter of the processor 24, and then transmitted to the display 25. Image signals associated with the line pair patterns 222, 223, and 224 from the image sensor 23 can be first processed by the analog-to-digital converter of the processor 24, and then transmitted to the optical resolution analyzer then finally to the display 25.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A system for measuring optical resolution of a lens, comprising:
a chart having a frame pattern and a plurality of line pair patterns arranged in the frame pattern, each of the line pair patterns including a plurality of black and white line pairs;
an image sensor center-aligned with the frame pattern of the chart for capturing an image of the chart;
a lens tray having a through hole for mounting the lens therein, the lens tray being movable relative to the chart for moving the lens to be center-aligned with the frame pattern of the chart and the image sensor based on the frame pattern in the image of the chart; and
a processor for analyzing the image of the line pair patterns to obtain an optical resolution of the lens.

2. The system as described in claim 1, wherein the frame pattern is highlighted relative to the line pair patterns.

3. The system as described in claim 1, wherein the frame pattern is rectangle.

4. The system as described in claim 1, wherein at least two of the line pair patterns are different from each other in spatial frequency.

5. The system as described in claim 4, wherein the line pairs of adjacent line pair patterns are perpendicular to each other.

6. The system as described in claim 1, further comprising a driving device for driving the tray to move.

7. A method for measuring a lens optical resolution, comprising:
providing a chart and an image sensor, the chart having a frame pattern and a plurality of line pair patterns arranged in the frame pattern, each of the line pair patterns including a plurality of black and white line pairs;
arranging the image sensor to align a central axis of an image sensing area of the image sensor with that of the frame pattern of the chart;
disposing the lens between the chart and the image sensor;
capturing an image of the chart using the image sensor;
determining whether the frame pattern in the image of the chart is centrosymmetric about a center of the image sensing area of the image sensor, if not, moving the lens until the frame pattern in the image of the chart is centrosymmetric about the center of the image sensing area of the image sensor;
capturing an image of the line pair patterns using the image sensor; and
analyzing the image of the line pair patterns to obtain an optical resolution of the lens.

8. The method as described in claim 7, wherein the frame pattern is highlighted relative to the line pair patterns.

9. The method as described in claim 7, wherein the frame pattern is rectangle.

10. The method as described in claim 7, wherein at least two of the line pair patterns are different from each other in spatial frequency.

11. The method as described in claim 10, wherein the line pairs of adjacent line pair patterns are perpendicular to each other.
